(19) United States
(12) Patent Application Publication
(10) Pub. No.: US 2015/0298456 A1
(43) Pub. Date: Oct. 22, 2015

(54) METHOD FOR INKJET PRINTING ON MOLDED ARTICLE

(71) Applicant: NIPPON CLOSURES CO., LTD., Tokyo (JP)

(72) Inventors: Sei NAKAGAWA, Kanagawa (JP); Hiroaki KIKUCHI, Kanagawa (JP); Katsumi HASHIMOTO, Kanagawa (JP)

(73) Assignee: NIPPON CLOSURES CO., LTD., Tokyo (JP)

(21) Appl. No.: 14/440,686

(22) PCT Filed: Oct. 29, 2013
(86) PCT No.: PCT/JP2013/079205

§ 371 Date: May 5, 2015

(30) Foreign Application Priority Data
Nov. 6, 2012 (JP) 2012-244074
Nov. 26, 2012 (JP) 2012-257073

(51) Int. Cl. B41J 2/14

(52) U.S. Cl. CPC B41J 2/14

(57) ABSTRACT

The present invention is a printing method for forming an inkjet-printed image 3 on the surface of a molded article 1, characterized by: forming an ink receiving layer 5 on a portion, where the printed image 3 is to be formed, by inkjet printing in correspondence with the printed image 3 prior to formation of the printed image 3 with an inkjet using an oil-based ink. This method can form the inkjet-printed image efficiently on the surface of the molded article 1.

### TECHNICAL FIELD

This invention relates to a method for inkjet printing on a molded article and, in particular, a method for inkjet printing suitable for forming a printed image on the top face of a plastic cap.

### BACKGROUND ART

Gravure printing, flexographic printing, etc. have been widely employed as industrial means of printing on the surfaces of various molded articles, for example, plastic caps or containers, plastic films and various other plastic molded articles. Recently, printing means by an inkjet method have come to be adopted.

The printing means by the inkjet method can form a printed image based on entered printing information by flying ink droplets by means of a nozzle head and depositing them on a predetermined recording medium to fix the deposits. Such printing means do not require plate making, and can make design changes easily. Thus, these printing means are suitable for printing on small-lot multi-kind products, and further have the advantage of low running costs.

Since the printing means possess the above-mentioned advantage, Patent Document 1, for example, proposes to form a printed image, which is formed on the top face of a plastic cap, by the inkjet method.

In doing printing by the inkjet method, it is necessary to avoid bleeding of ink or the like. With the inkjet printing, therefore, it is common practice to coat an ink receiving layer beforehand on the surface of a printing medium, which is to undergo printing, for preventing bleeding due to an ink flow or peeling of a printed image (see, for example, Patent Document 2).

### PRIOR ART DOCUMENTS

### Patent Documents

Patent Document 1 JP-A-2003-11342

Patent Document 2 JP-A-2008-213199

### SUMMARY OF THE INVENTION

### Problems to be Solved by the Invention

In forming a printed image by an inkjet on the surface of the printing medium having the ink receiving layer formed thereon as mentioned above, the printing medium, if prepared from plastic, poses the problem of causing a great decrease in productivity. That is, a coating solution for use in the formation of the ink receiving layer contains a solvent, and thus after the solvent is dried and removed, printing with an inkjet is done. If the printing medium is a plastic one, heating for drying and removal of the solvent (namely, curing of a coating film) is limited. This is because if the coating film is heated to a high temperature to shorten the heating time, the substrate to be printed on (the molded article) is deformed. Particularly when the plastic is a thermoplastic resin with low resistance to heat, such as polyolefin, a tendency toward such deformation is marked.

It is an object of the present invention, therefore, to provide an inkjet printing method capable of forming an inkjet-printed image efficiently on the surface of a molded article.

### Means for Solving the Problems

According to the present invention, there is provided an inkjet printing method for forming an inkjet-printed image on the surface of a molded article, comprising:

forming an ink receiving layer on a portion, where the printed image is to be formed, by inkjet printing in correspondence with the printed image prior to formation of the printed image with an inkjet using an oil-based ink.

In the inkjet printing method of the present invention, it is preferred that

(1) the ink receiving layer be formed by inkjet printing using an ink for a receiving layer, the ink comprising a wet type resin dispersed in a solvent;

(2) the ink receiving layer be formed by inkjet printing using the ink for a receiving layer, the ink comprising the wet type resin and inorganic fine particles dispersed in the solvent;

(3) the printed image formed with the inkjet be a local image;

(4) the molded article be a cap or a container;

(5) the cap be composed of plastic, and the inkjet-printed image be formed on the top face of the cap; and

(6) the top face of the plastic cap be formed in a thin-walled top panel having a thickness of 2.0 mm or less, particularly, 1.5 mm or less.

### Effects of the Invention

The present invention has a remarkable characteristic in that the ink receiving layer for fixing the inkjet-printed image is formed by the inkjet method, as is the printed image, in correspondence with the printed image. If the inkjet-printed image is a local image such as a character, a line or a point, for example, the ink receiving layer can be formed with an inkjet in correspondence with the portion where such a local image is to be formed.

Such formation of the ink receiving layer by the inkjet method, compared with the formation of the ink receiving layer by other coating method, is advantageous in that the removal of the solvent by heat-drying can be performed under very mild conditions and, even if the solvent is not completely removed, but remains in some amount, subsequent formation of a printed image by inkjet printing can be performed. If the inkjet-printed image is a local image such as a character, a line or dots, the advantages are also obtained that the amount of the receiving layer coated can be cut down to a minimum, and the costs of the materials can be reduced.

In detail, in forming the ink receiving layer by the inkjet method, an ink material for forming the ink receiving layer (i.e., ink for a receiving layer) is ejected as a jet. Thus, the ink receiving layer is formed, with so-called spray drying being performed, so that the amount of the solvent contained in the resulting undried ink receiving layer is significantly small. Moreover, this ink receiving layer may be formed selectively in the portion where the inkjet-printed image is to be formed, and thus the ink receiving layer need not be formed in a larger area than required. Furthermore, the receiving layer is not intended to form a printed image. On this receiving layer, therefore, an inkjet-printed image can be formed, with the receiving layer containing some amount of the solvent. Consequently, solvent removal by heat drying, which is carried out before inkjet printing, can be performed under very mild conditions (concretely, low temperature, short time), whereby productivity can be increased.

In addition, the present invention enables printing with the inkjet and formation of the ink receiving layer to be performed as a series of actions on the same line without interruptions. Hence, a marked increase in productivity can be achieved.

The inkjet printing method of the present invention is executed on the surfaces of various molded articles, for example, plastic caps, plastic containers, plastic films and various other plastic molded articles; and the surfaces of metallic caps and metallic cans.

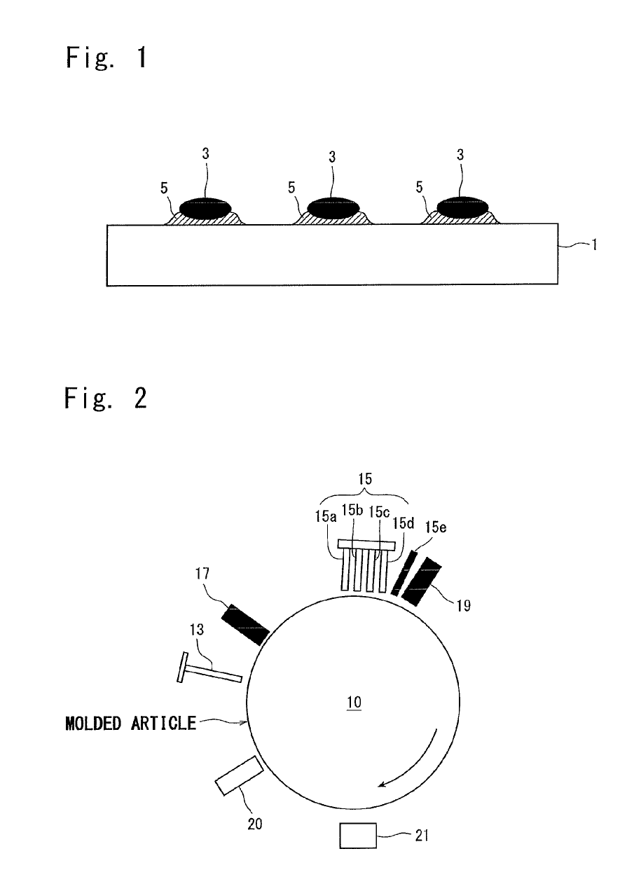

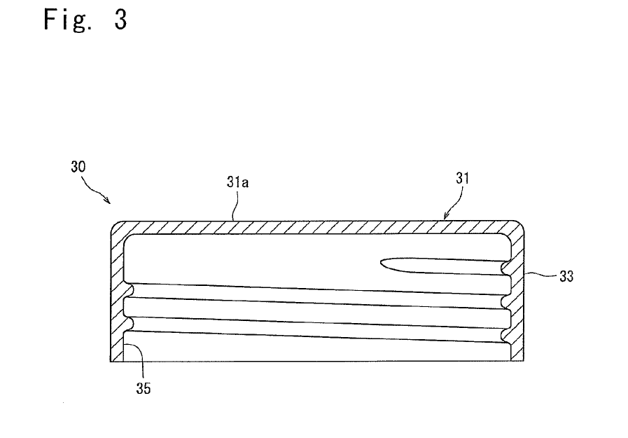

### BRIEF DESCRIPTION OF THE DRAWINGS

[FIG. 1] is a view showing the relationship between an ink receiving layer and an ink image which are formed by the present invention.

[FIG. 2] is a view for illustrating the process for carrying out the present invention.

[FIG. 3] is a view showing a cap, a typical example of a molded article, for which the present invention is carried out in the most preferred manner.

### BEST MODE FOR CARRYING OUT THE INVENTION

By reference to FIG. 1, with the inkjet printing method of the present invention, a printed image 3 is formed on the surface of a molded article 1 by inkjet printing using an oil-based ink. The inkjet-printed image 3 is formed on an ink receiving layer 5 which is formed by inkjet printing.

The molded article 1 is not limited, and may be formed from any thermoplastic resin or any thermosetting resin. Generally, however, the formation of the molded article 1 from a resin with low resistance to heat, for example, a thermoplastic resin, is advantageous in making the most of the benefits of the present invention. That is, according to the present invention, the receiving layer 5 for fixing the inkjet-printed image can be formed under mild conditions involving low temperature, short-term drying, as stated earlier. The reasons are that even when the molded article 1 is formed from a resin with low resistance to heat, such as a thermoplastic resin, its thermal deformation is effectively suppressed, and a long time is not required until inkjet printing is completed.

In the present invention, the inkjet-printed image 3 is formed with an oil-based ink for an inkjet which is itself publicly known. The inkjet-printed image 3 may be formed with an ink of a single color, or may be a full-color image formed with inks of different colors overlapped.

The oil-based inks for an inkjet contain various solvents, pigments or dyes of various colors, and dispersing agents.

Typical examples of the solvent are hydrocarbon solvents such as aliphatic hydrocarbons or aromatic hydrocarbons, alkyl alcohol solvents, halogenated hydrocarbon solvents, ether solvents, glycol ether solvents, ketone solvents, ester solvents, and polyhydric alcohol solvents. The amount of any of these solvents is set so that the resulting ink has such a viscosity as to be ejected as fine particles through a nozzle head.

Examples of the pigment or dye are those of various colors publicly known per se, and include carbon black, cadmium red, molybdate red, chrome yellow, cadmium yellow, titan yellow, chromium oxide, viridian, cobalt green, ultramarine blue, Prussian blue, cobalt blue, azo pigments, phthalocyanine pigments, quinacridone pigments, isoindolinone pigments, dioxazine pigments, threne pigments, perylene pigments, thioindigo pigments, quinophthalone pigments, and metal complex pigments. Any of these pigments or dyes is used according to the intended color.

Further, the dispersing agents are also publicly known per se, and their examples include hydroxyl group-containing carboxylic acid esters, salts of long chain polyaminoamides and high molecular weight acid esters, salts of high molecular weight carboxylic acids, salts of long chain polyaminoamides and polar acid esters, high molecular weight unsaturated acid esters, modified polyurethanes, modified polyacrylates, polyether ester type anionic surface active agents, naphthalenesulfonic acid formalin condensate salts, polyoxyethylene nonylphenyl ether, polyester polyamine, and stearylamine acetate.

Furthermore, the above-mentioned oil-based ink may appropriately contain, as a binder, a polymerizable monomer which is thermosetting, ultraviolet curing, or electron beam curing. For example, the oil-based ink may contain, together with a polymerization initiator, a monomer component which forms a polyester, an epoxy resin, a polyurethane, or an acrylic-modified product of any of these polymers. The oil-based ink may further contain, in addition to any of them, a reactive diluent such as an acrylic monomer.

In the present invention, the ink receiving layer 5 preferably has such a color tone as not to impair the color shade of the printed image by inkjet printing, and is formed by inkjet printing in this manner. That is, such an ink receiving layer 5 may be transparent, or may be formed with an ink which has been colored with a pigment or dye publicly known per se so as to have a color tone not impairing the color shade of the printed image.

Such an ink for formation of the ink receiving layer comprises a wet type resin dispersed in a solvent. This ink may incorporate, if necessary, inorganic fine particles, a dispersing agent, and further a pigment or dye.

The wet type resin used in the ink for formation of the ink receiving layer swells in the aforementioned solvent contained in the oil-based ink. When a sheet composed of such a resin is immersed at room temperature (25° C.) in the solvent used, for example, an increase in the volume of the sheet due to penetration of the solvent is observed. Concretely, a polyvinyl alcohol resin, a polyester resin, an epoxy resin, an acrylic resin, a urethane resin or the like is used according to the type of the solvent contained in the oil-based ink. Since the ink receiving layer 5 contains such a wet type resin, when inkjet printing using the oil-based ink is performed subsequently, the oil-based ink for forming a printed image promptly penetrates into the ink receiving layer 5. The wet type resin is generally used in an amount of 1 to 20% by weight based on the solids content of the ink for a receiving layer.

The inorganic fine particles are used for the purpose of stably holding the ink penetrating into the receiving layer 5. Such inorganic fine particles have a volume average particle diameter (D₅₀), as measured, for example, by the laser diffraction/scattering method, of 5 μm or less. Generally, colloidal silica or the like can be used, but fine particles of a layered silicate compound, such as mica, vermiculite, or smectite, are used preferably. These fine particles of the layered silicate compound are a porous material containing many pores, and are capable of more stably holding the oil-based ink penetrating into the receiving layer 5. The inorganic fine particles are generally used in an amount of 1 to 30% by weight based on the solids content of the ink for a receiving layer.

As the solvent for use in the ink for a receiving layer, there can be cited, as examples, the same solvents as the aforementioned solvents used in the oil-based ink. The amount of the solvent is set so that the ink for a receiving layer has such a viscosity as can be jetted from the head of an inkjet nozzle.

The dispersing agent usable in the ink for a receiving layer may be the same as any of the aforementioned ones usable in the oil-based ink, and is used in such an appropriate amount that the pigment or the like in the ink does not precipitate.

The pigment or dye which can be incorporated in the ink for a receiving layer, needless to say, is one not impairing the color tone of the inkjet-printed image 3 to be formed on the receiving layer, and is incorporated in such an amount as to meet this condition.

Further, the above-mentioned ink for a receiving layer, like the ink for an inkjet, may incorporate a thermosetting, ultraviolet curing, or electron beam curing polymerizable monomer, together with a polymerization initiator, or a reactive diluent such as an acrylic monomer.

The formation of the ink receiving layer 5 using the above ink for a receiving layer, and the subsequent formation of the inkjet-printed image are carried out according to the process shown in FIG. 2.

That is, as shown in FIG. 2, a rotary transporter 10, which transports a molded article to be printed on, is provided for performing the above process. An inkjet head 13 for a receiving layer, and a head 15 for inkjet printing are arranged, with spacing from the surface of the rotary transporter 10, and in this sequence along the direction of rotation. In the head 15 for inkjet printing, a head C (15a) for cyan (blue) ink, a head M (15b) for red (magenta) ink, a head Y (15c) for yellow ink, a head K (15d) for black ink, and a head W (15e) for white ink, for example, are arranged in an appropriate order along the rotating direction of the rotary transporter 10 so that full-color printing, for example, can be done. Of course, these ink heads for five colors are not limitative, and heads for more colors may be arranged in an appropriate sequence so that a printed image in full colors can be formed by overlapping inks of these colors.

Moreover, a heater 17 for drying the ink for a receiving layer is disposed between the inkjet head 13 for a receiving layer and the head 15 for inkjet printing. Further, a drying heater 19 for an inkjet-printed image is disposed downstream, in the rotating direction of the rotary transporter 10, of the head 15 for inkjet printing. A spot cooler 20 for cooling the surface of the rotary transporter 10 by, say, blowing of cold air is disposed upstream, in the rotating direction of the rotary transporter 10, of the inkjet head 13 for a receiving layer.

In detail, according to the present invention, a molded article (e.g., a cap) to undergo printing is introduced, for example, onto the surface of the rotary transporter 10 at a position between the inkjet head 13 and the spot cooler 20. First of all, in accordance with the morphology of the desired inkjet-printed image, the aforementioned ink for a receiving layer is jetted at a portion, where the printed image is to be formed, in a gush through the inkjet head 13. Then, the solvent is removed by heating by means of the heater 17 to form an ink receiving layer 5 (see FIG. 1) ascribed to the ink.

After formation of the ink receiving layer 5 in this manner, jets of the oil-based inks of the respective colors are emitted in an appropriate order by the above-described inkjet head 15, whereby a full-color inkjet-printed image 3 (see FIG. 1) matching the purpose is formed. Such a printed image is dry-heated by the succeeding heater 19, completely fixed to the ink receiving layer 5 thereby, and finally discharged from the rotary transporter 1.

In performing the formation of the ink receiving layer 5 and the inkjet-printed image 3 as above, the rotary transporter 10 is heated by the heaters 17 and 19, and is expected to have its temperature gradually rising. However, this disadvantage is effectively prevented by cooling with the spot cooler 20.

If the molded article 1 is made of plastic or the like, moreover, a surface treatment device 21 for introducing a polar group into the surface of the molded article 1 can be disposed on the upstream side, in the rotating direction, of the spot cooler 20 in order to enhance adhesion between the ink receiving layer 5 and the molded article 1.

This surface treatment device 21 carries out, for example, corona treatment to introduce a polar group into a region of the molded article 1, which includes a portion where inkjet printing is applied (a portion where the ink receiving layer 5 is to be formed), thereby improving the adhesion between the molded article 1 and the ink receiving layer 5.

If the ink for forming the ink receiving layer 5 contains an ultraviolet curing or electron beam curing polymerizable monomer, curing by irradiation with ultraviolet rays or electron beams may be performed after heating by the heater 17, but before the next step, inkjet printing. Normally, however, if heating by the heater 17 (i.e., temporary baking) is performed to remove the solvent moderately, the coating film can function as the receiving layer 5. Thus, such curing is desirably performed after inkjet printing is done. If the thermosetting monomer is incorporated, moreover, it is recommendable to restrict the curing by the heater 17 to such heating as will remove the solvent, depending on the curing conditions, and to carry out main heating after inkjet printing is done.

Besides, if the ink for an inkjet contains a thermosetting, ultraviolet curing or electron beam curing polymerizable monomer, it is desirable that temporary baking by heating by means of the heater 19 be performed to remove the solvent, whereafter main curing (baking) be performed finally, in a separate step, by main heating, irradiation with ultraviolet rays, or irradiation with electron beams.

In the present invention, as described above, the ink receiving layer 5 for fixing the inkjet-printed image is formed by the inkjet method, as for the printed image, in correspondence with the printed image. Thus, heating by the heater for fixing the ink receiving layer 5 (removal of the solvent) can be performed under mild conditions, namely, a low temperature and a short period of time for heating. Hence, subsequent formation of the inkjet-printed image can be carried out immediately and consecutively upon transport by the rotary transporter 10. Consequently, the productivity of the printed image is remarkably increased.

In detail, when the ink receiving layer 5 is to be formed by the inkjet method, printing for forming this ink receiving layer 5 is performed by jets from the head 13. During the jetting, the solvent in the ink for a receiving layer is removed to some extent (as in spray drying). Moreover, the ink receiving layer 5 can be selectively formed in a portion where an inkjet-printed image is to be formed later. Furthermore, the ink receiving layer 5, even if slightly flowing and bleeding, becomes larger in size than the inkjet-printed image 3 to be formed afterwards. Thus, it is permitted for some amount of the solvent to be contained. As will be understood from this fact, the heating by the heater 17 may be performed at a relatively low temperature (for example, 120° C. or lower) for a short period of time. Hence, it becomes possible to perform inkjet printing immediately using the head 15.

In the present invention, the printed image formed by inkjet printing may be a solid image, but optimally is a local image such as a character image. That is, in the case of the solid image, the ink receiving layer 5 formed is also solid and has a large area. In the case of the local image, on the other hand, the ink receiving layer 5 is also dotted and has a small area, and the removal of the solvent by heating can be performed in an even shorter time.

In the present invention described above, the molded article 1 undergoing printing may be formed from any material, such as plastic, a metal or glass, but is preferably made of plastic. In regard to its shape, the molded article 1, particularly when made of plastic, is typically a cap or a container, but is most preferably a cap.

In FIG. 3 schematically showing such a typical plastic molded article, the above cap (indicated entirely at 30) comprises a top panel 31 having a flat surface, and a skirt 33 downwardly extending from the circumferential edge of the top panel 31. On the inner surface of the skirt 33, a thread 35 is formed for fixing the cap 30 onto the outer surface of the mouth of a container (not shown). With a type of cap which forms a sealing structure by relying on turning or the like, rather than on threaded engagement with the thread 35, a seal ring or the like for forming a seal is provided, instead of the thread 35, on the inner surface of the top panel 31.

The above-mentioned plastic cap is generally formed of an olefin resin such as polypropylene or polyethylene. Its heat resistance is low, and it has, formed therein, the thread 35 (or seal ring) or the like which is extremely susceptible to heat deformation. According to the present invention, drying for removal of the solvent can be carried out under mild conditions. With the present invention, therefore, when the inkjet-printed image 3 is to be formed on the top face 31a of the plastic cap (upper surface of the top panel 31), the printed image can be formed at a high speed, with the heat deformation of the cap 3 being effectively prevented. In this manner, effective use can be made of the advantages of the present invention.

In addition, the above cap is further preferably designed such that the top panel having the top face, on which printing is to be done, has a small wall thickness of 2.0 mm or less, particularly 1.5 mm or less. From the resource-saving point of view, for example, there has been a trend toward the wall thinning of caps. In such a case, there is a possibility that warpage or the like will occur in the top panel 31 of the cap 30 formed by thermoforming such as injection molding or compression molding. If such warpage occurs, the problem arises that a printed image blurs in the case of printing by press contact with a roll, for example, as in gravure printing. In the present invention, such a trouble can be completely solved, because the ink receiving layer 5 and the printed image 3 are both formed from flying droplets of ink by the inkjet method. Even when the top face of the cap is satinized in order to impart design properties or reduce friction during transport, moreover, the ink receiving layer 5 and the printed image 3 can be formed at the bottom of concavities of the uneven surface without blurring.

With the foregoing present invention, the site where printing takes place is not limited to the top face of the cap, but the side surface of the molded article can be printed. If the range of printing is a wide range in the circumferential direction of the molded article, the molded article is rotated on its axis, and its side surface can be printed by the method of the present invention.

According to the present invention described above, the formation of the printed image on the molded article can be performed at a high speed, with thermal deformation of the molded article being effectively prevented, with the result that very high productivity can be ensured.

### Explanations of Letters or Numerals

1: Molded article
3: Inkjet-printed image
5: Ink receiving layer
10: Rotary transporter
13: Head for ink receiving layer
15: Head for inkjet-printed image
17, 19: Heater
20: Spot cooler
21: Surface treatment device
30: Plastic cap
31: Top panel
33: Skirt
35: Thread

1. An inkjet printing method for forming an inkjet-printed image on a surface of a molded article, comprising:
forming an ink receiving layer on a portion, where the printed image is to be formed, by inkjet printing in correspondence with the printed image prior to formation of the printed image with an inkjet using an oil-based ink.

2. The inkjet printing method according to claim 1, wherein
the ink receiving layer is formed by inkjet printing using an ink for a receiving layer, the ink comprising a wet type resin dispersed in a solvent.

3. The inkjet printing method according to claim 2, wherein
the ink receiving layer is formed by inkjet printing using the ink for a receiving layer, the ink comprising the wet type resin and inorganic fine particles dispersed in the solvent.

4. The inkjet printing method according to claim 1, wherein
the printed image formed with the inkjet is a local image.

5. The inkjet printing method according to claim 1, wherein
the molded article is a cap or a container.

6. The inkjet printing method according to claim 5, wherein
the cap is composed of plastic, and the inkjet-printed image is formed on a top face of the cap.

7. The inkjet printing method according to claim 6, wherein
the top face of the plastic cap is formed in a thin-walled top panel having a thickness of 2.0 mm or less.
